(19) United States
(12) Patent Application Publication
(10) Pub. No.: US 2012/0238365 A1
(43) Pub. Date: Sep. 20, 2012

(54) VIDEO GAME HARDWARE SYSTEMS AND SOFTWARE METHODS USING PHYSICAL OBJECTS FOR IMMERSIVE INTERACTIONS WITH VIDEO GAMES

(76) Inventors: Andrea Gaiba, (US); Davide Squarise, (US); Lorenzo Godina, Pavia (IT)

(21) Appl. No.: 13/051,346

(22) Filed: Mar. 18, 2011

(51) Int. Cl. A63F 13/00; A63F 13/06

(52) U.S. Cl. 463/32; 463/37

(57) ABSTRACT

Player may manipulate a physical cube or polygon directly identifying its actions performed on 3-axis in physical space with the corresponding actions performed on 3-axis in the virtual space by moving a solid, a polygon or a similar shape displayed on screen or monitor.

Additionally or alternatively, player may wear plastic clips or belt (or made of different materials, colors, shapes), used as holders for motion detection control/input devices or other control/input devices, in order to play games by player's body movements not requiring use of player's hands in order to use such control/input devices (for example, dancing games). Player may wear clips or belt in order to secure the control/input device for easy and quick accessibility, used as safe holders for the control/input devices while keeping other input devices in its hands (for example, a microphone).

### CROSS REFERENCE TO RELATED APPLICATION

This application is a non-provisional application of and claims the benefit of priority from U.S. Provisional Application Ser. No. 61/161,917, entitled “Video Game Hardware Systems and Software Methods Using Head Tracking” filed Mar. 20, 2009.

### BACKGROUND

At times the best ideas come from simple observation of the phenomena that have made history in gaming entertainment. At other times, they come from concepts that are miles away from standard market rules. A new generation of video games were thought to make human and computer device interacting in an absolutely original way, were the players define the interaction with the game and not vice versa, creating a real “immersive” experience (the type of interaction is not “player's finger—joystick button” but participation and sensorial, physical and mental immersion of the player).

The intention of the project is to make player experiencing a new way of interacting with video game, through immersivity and sensorial experience.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

Aspects of the present disclosure relate to manipulation of a physical object that can be directly identified with a corresponding 3D object in a videogame. This system improves identification of physical actions with movements performed within a virtual 3D space. For example, a plastic cube or a plastic block, with a hollow that contains a motion sensing game controller, can be used to link physical movements, performed on the plastic cube, with actions performed on corresponding 3D blocks displayed on screen. In one example, the player may be required to rotate or move falling “Tetraminoes” or 3D blocks displayed on a TV screen or computer monitor. Accordingly, player, by rotating the physical plastic cube may rotate a similar 3D object displayed on screen, quickly identifying movement along the 3D axis in the game environment thanks to identification of the same movements performed, in the real world, on the plastic cube. In another example, player may control actions and movements of video game characters and objects displayed on TV screen or computer monitor by physical movements of a plastic cube containing a motions sensing device. In yet another example, player may use a plastic cube or a sponge made colored cube, in combination with cameras or video capturing devices connected to the game system, to identify its physical actions with the corresponding actions displayed on screen. Using the above example system and methods, a player may consciously control and affect his or her movements within a virtual 3D space reflecting his or her physical actions or movements.

According to another aspect, a video game may receive control input through multiple control devices including a passive input device and an active input device. In one or more arrangements, these input devices may be coupled or otherwise connected (wired or wirelessly) to one another to affect operation of each other. For example, active input received through an active input device may alter the type of data detected by the passive input device. In another example, a passive device may communicate with a game console through the active input device.

According to another aspect, player may command actions in a game through combination of body movements detected by motion sensing devices, without use of hands to play. For example, player may put motion sensing controllers in plastic clips to be worn on player's hips, commanding the movements of “Tetraminoes” or 3D blocks displayed on TV screen, or computer monitor, through body movements. In another example, player may replicate and recreate, on TV screen or computer monitor, dance movements by wearing motion sensing devices, using plastic clips to be put on player's hips as holders for such control/input devices. In yet another example, player may control the actions and movements of a video game character or other 3D objects through body movements made wearing motion sensing devices inserted in plastic clips to be put on player's hips. One or multiple clips can be used at the same time to hold control/input devices.

According to yet another aspect, player may use plastic clips, to be worn on player's hips, as case or holder for controllers and motion sensing devices while playing video game. For example, player may want to play a singing game holding a microphone, so it is not possible for him or her to hold a controller in the same hand. The plastic clips may be used to hold the controllers without using hands, allowing, at the same time, easy and quick access to controller buttons and other controls.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment and hardware devices in which various aspects of the disclosure may be used.

FIG. 2 illustrates an example video game console and associated controller devices according to one or more aspects described herein.

FIG. 3 illustrates an example process flow generating different video games and settings according to one or more aspects described herein.

FIG. 4 illustrates an example profile selection interface according to one or more aspects described herein.

FIG. 5 illustrates an example input name interface according to one or more aspects described herein.

FIG. 6 illustrates an example main menu interface according to one or more aspects described herein.

FIG. 7 illustrates an example 3D mascot designs and animations according to one or more aspects described herein.

FIG. 8 illustrates an example Play menu interface according to one or more aspects described herein.

FIG. 9 illustrates an example Options menu interface according to one or more aspects described herein.

FIG. 10 illustrates an example Recap Screen menu interface according to one or more aspects described herein.

FIG. 11A illustrates an example game interface according to one or more aspects described herein.

FIG. 11B illustrates an example of “Ice” game environment/theme.

FIG. 11C illustrates an example of “Desert” game environment/theme.

FIG. 11D illustrates an example of “Hunted Castle” game environment/theme.

FIG. 11E illustrates an example of “Underwater” game environment/theme.

FIG. 11F illustrates an example of “Moon” game environment/theme.

FIG. 11G illustrates an example game interface for multiplayer mode according to one or more aspects described herein.

FIG. 12 illustrates an example Pause menu interface according to one or more aspects described herein.

FIG. 13 illustrates an example End Screen menu interface according to one or more aspects described herein.

FIG. 14 illustrates an example Tutorial menu interface according to one or more aspects described herein.

FIG. 15 illustrates an example Game Settings menu interface according to one or more aspects described herein.

FIG. 16 illustrates an example Statistics menu interface according to one or more aspects described herein.

FIG. 17 illustrates an example Controllers menu interface according to one or more aspects described herein.

FIG. 18 illustrate example of Viewpoint visualization modes according to one or more aspects described herein.

FIG. 19 illustrate example of plastic clips and plastic cube devices according to one or more aspects described herein.

FIG. 20, FIG. 21 and FIG. 22 illustrate example of game play commanding game actions through combination of control/input device 202 and device 209.

FIGS. 23A, 23B, 23C, 23D illustrate example concept design according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

In addition, the following description includes one or more aspects that may be used alone or in combination with each other. For example, the plastic cube and plastic clips may be used with the below described games and software, or with other games and software. The plastic cube and plastic clips may be used with any game console, computing device, server, digital video recorder (DVR), mobile device, networked device, etc. The individually described games may be playable with or without the plastic cube and/or plastic clips, and may be played in different manners than specifically described. The below descriptions are for illustrative purposes to enable multiple embodiments of each invention contained herein. Applicant reserves the right to pursue each invention individually or in combination with one or more other inventions described herein.

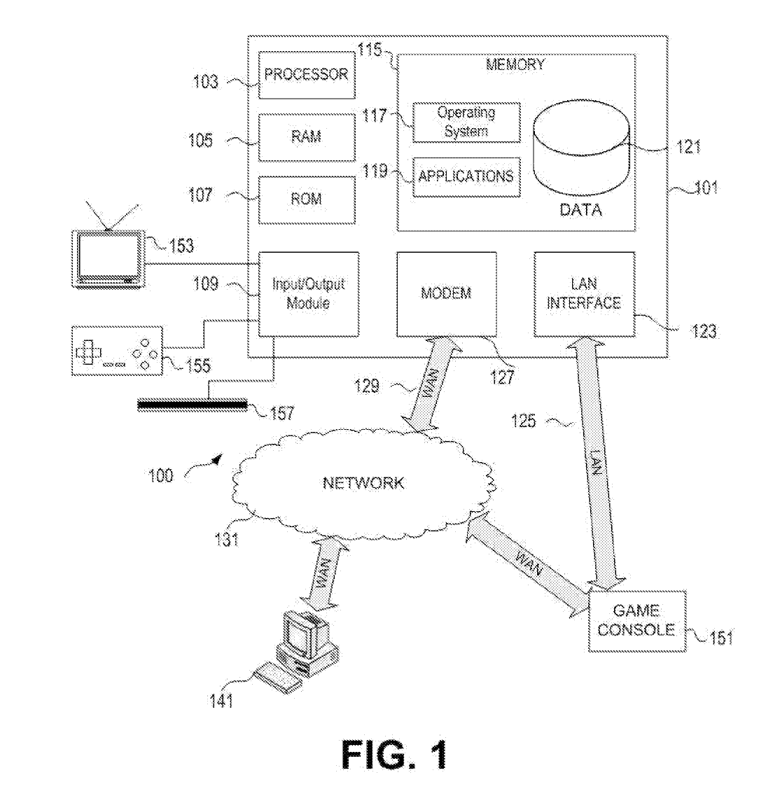

FIG. 1 illustrates a block diagram of a computing device 101 (e.g., a gaming console) in computing environment 100 that may be used according to an illustrative embodiment of the disclosure. The gaming device 101 may have a processor 103 for controlling overall operation of the server and its associated components, including random access memory (RAM) 105, read-only memory (ROM) 107, input/output (I/O) module 109, and memory 115

I/O 109 may include a microphone, mouse, keypad, touch screen, scanner, optical reader, video-camera, weight detection and control devices and/or stylus (or other input device(s)) through which a user of gaming device 101 may provide input, and may also include one or more of a speaker for providing audio output and a video display device for providing textual, audiovisual and/or graphical output. For example, I/O 109 may include one or more software and/or firmware adapters configured to enable communications with one or more input or output device such as display device 153 (e.g., a television), a game controller 155 and a motion sensor 157. Gaming device 101 may thus output images such as the movement of various elements of an electronic game on display device 153 based on and/or in response to the control input received through controller 155 and sensor 157 (e.g., depression buttons of controller 155 and movement detected by sensor 157). Software may be stored within memory 115 and/or other storage to provide instructions to processor 103 for enabling gaming device 101 to perform various functions. For example, memory 115 may store software used by the gaming device 101, such as an operating system 117, application programs 119, and an associated database 121. Alternatively, some or all of device 101 computer executable instructions may be embodied in hardware or firmware (not shown).

The gaming device 101 may operate in a networked environment supporting connections to one or more remote computers, such as terminals 141 and 151. The terminals 141 and 151 may be personal computers, gaming consoles or servers that include many or all of the elements described above relative to the gaming device 101. For example, gaming device 101 may be in network communication with gaming console 151, thereby allowing co-operative or competitive gaming between users of device 101 and console 151. The network connections depicted in FIG. 1 include a local area network (LAN) 125 and a wide area network (WAN) 129, but may also include other networks. When used in a LAN networking environment, the gaming device 101 may be connected to the LAN 125 through a network interface or adapter 123. When used in a WAN networking environment, the gaming device 101 may include a modem 127 or other network interface for establishing communications over the WAN 129, such as network 131. Network 131 may, for instance, comprise the Internet. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Gaming device 101 and/or terminals 141 or 151 may also comprise mobile terminals (e.g., mobile phones, PDAs, notebooks, netbooks, tablets, etc.) including various other components, such as a battery, speaker, transceivers and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, gaming platforms, distributed computing/gaming environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

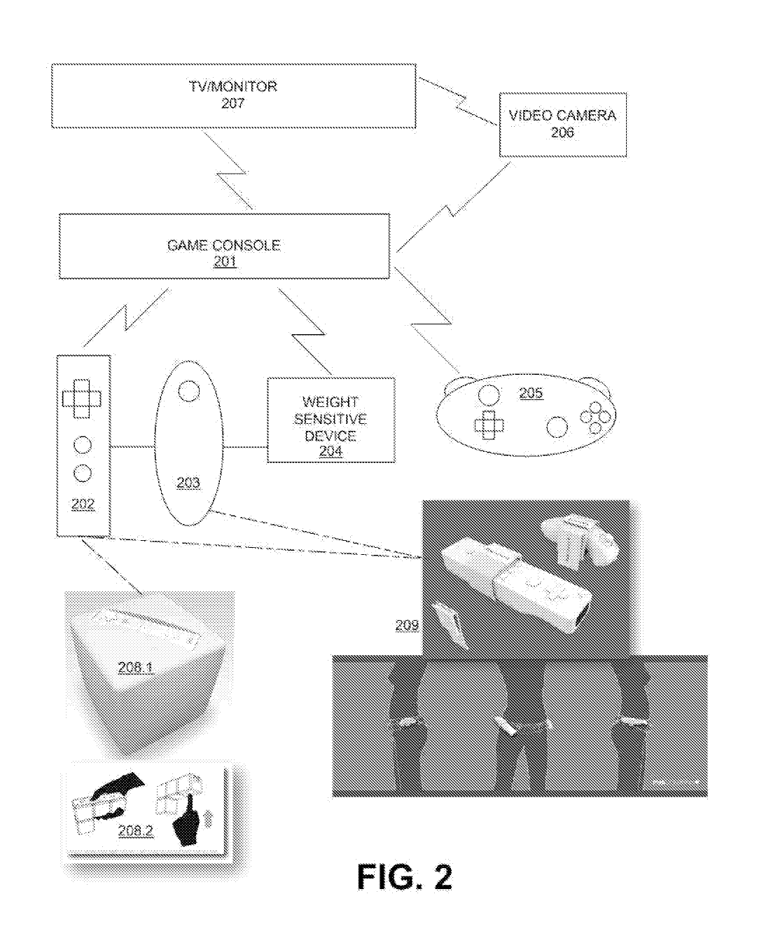

According to various aspects described herein, gaming console 101 may be used to play a video game which consists of new interactions providing new sensorial experience to the player. In some example, player should move and command colored “Tetraminoes”, displayed on TV screen or computer monitor, within a set timeline in order to complete a match avoiding game over. Accordingly, a plastic cube or plastic clips can be used to enhance the interaction with the console, through “sensorial extension” of control/input devices. FIG. 2 illustrates a gaming console 201 that may be wired or wirelessly connected to control/input devices 202, 203, 204, 205, 206. Control devices 202 and 203 may comprise a pair of handheld controls that may be coupled and/or otherwise connected to one another. In one example, control device 202 may be configured for use in one hand while control device 203 may be configured for use in the other hand, allowing console 201 and a game to detect motions of both hands of a player. Hand control devices 202 and 203 may include components configured to detect various types of input including hand motions and characteristics. For example, devices 202 and 203 may include multi-axis accelerometers to detect changes in orientation (e.g., rotation, tilt) of devices 202 and 203 and a motion sensor device (e.g., an infrared sensor tag) for tracking changes in position of devices 202 and 203. The connection between devices 202 and 203 may be wired or wireless and may allow device 203, for example, to communicate with console 201 if device 203 does not have its own communication capabilities. Alternatively or additionally, coupling or otherwise connecting devices 202 and 203 may allow changes or interactions of one device (e.g., device 202) to change or alter the operation of the other device (e.g., device 203).

Devices 204 and 206 may be configured to detect player attributes other than hand movements and orientation. For example, device 204 may comprise a board or platform upon which a user may stand or sit or perform other actions. Device 204 may include one or more weight sensors to determine shifts in weight, a user's level of balance, a position of a user's feet and the like. Accordingly, in one or more arrangements, device 204 may be used to determine a player's overall stability by determine a magnitude of any shifts in the player's weight. In another example, device 206 may be configured to video capture, detect, track player's body and facial movements and state or to capture, detect, track movements and shape of physical objects used by player, and to use such captured or detected movements as input commands in video game.

Devices 208.1, 208.2 and 209 are not input devices but may be used as physical extension to 202 and/or 203 controllers in order to enhance the correspondence between actions physically performed by player and actions displayed in a video game.

Device 209 may be also configured as case or holder for 202 and/or 203 controllers while playing video game. For example, player may want to play a singing game holding a microphone, so it is not possible for him or her to hold a controller in the same hand. Device 209 may be used to hold devices 202 and/or 203 without using hands, allowing, at the same time, easy and quick access to device 202 and/or 203 buttons and other controls.

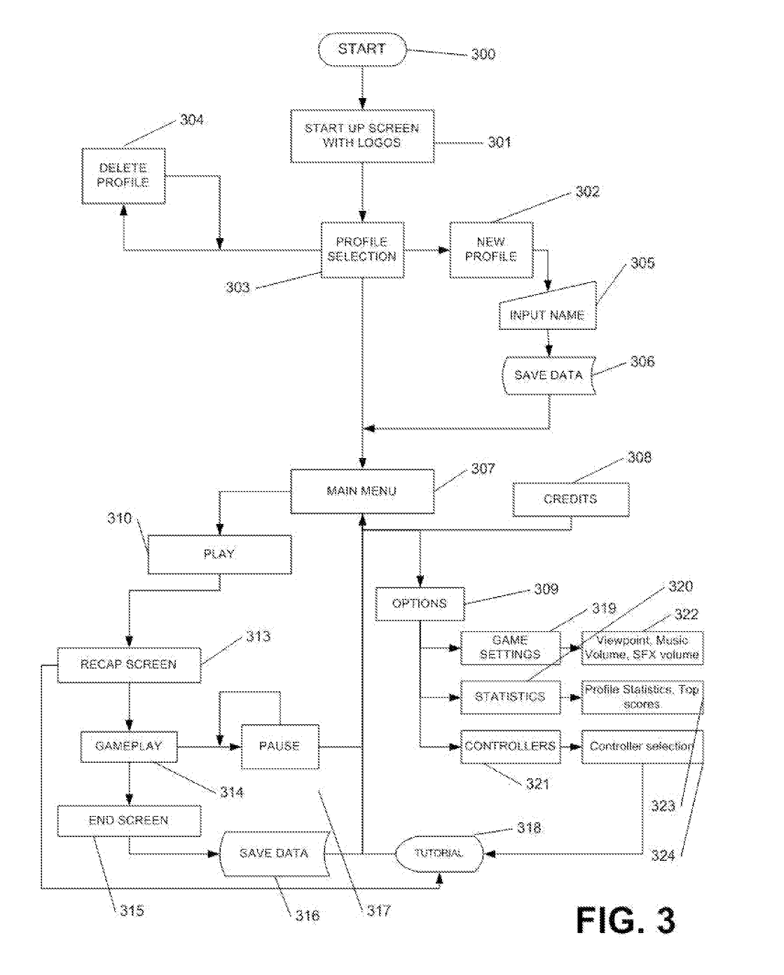

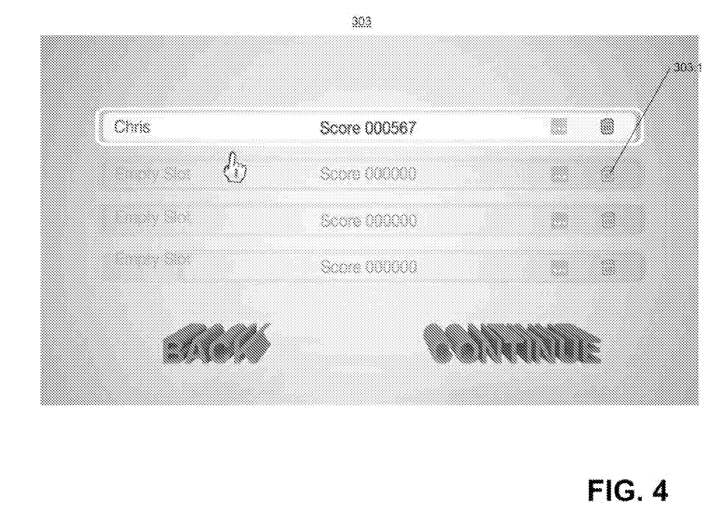

FIG. 3 is a flowchart illustrating a method by which a user may initiate a video game with enhanced sensorial experience. In steps 303 and 307, a gaming system such as gaming device 101 of FIG. 1 may generate and display console menus through which a player may select various games, functions and applications. For example, the menu may include movie playing functionality, video game playing functionality, an Internet browser application, a marketplace or store and the like. In step 310, the gaming system may receive a selection of video game functionality from an input device such as controller 202 of FIG. 2. The video game functionality may correspond to a currently loaded video game or a plurality of available video games. With selection 303, gaming system may display a profile selection menu for the video game. A player may: (i) select a previously saved profile (step 303) then continue to Main Menu 307; (ii) create a new profile (steps 302, 305 and 306) then continue to Main Menu 307; delete a previously saved profile (304) by selecting the “trash” icon (selection 303.1) then going back to menu 303. A profile may define various user characteristics such as name and/or appearance of an avatar.

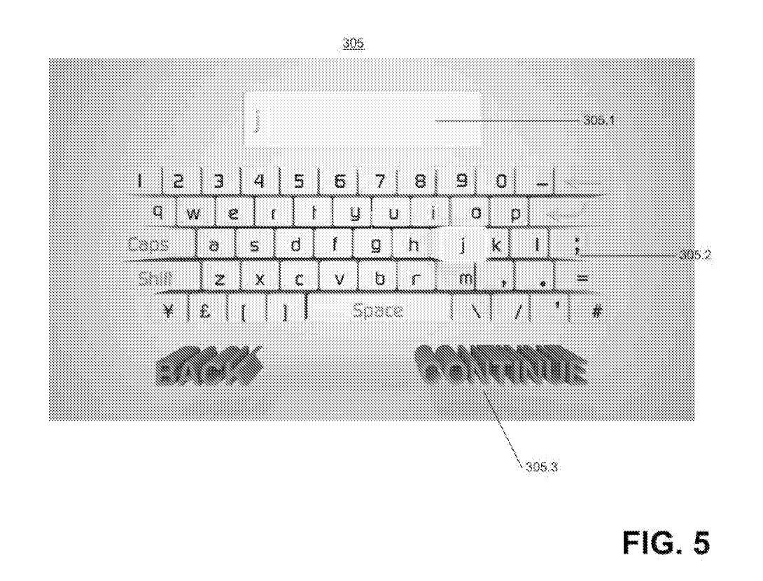

FIG. 5 illustrates an example input name menu 305. Player using input device 202 may perform selections on the displayed virtual keyboard (305.2) typing the preferred profile name. The name typed is displayed in the field 305.1. By selecting “continue” (305.3) button the system saves data typed (306) then continues to Main Menu 307.

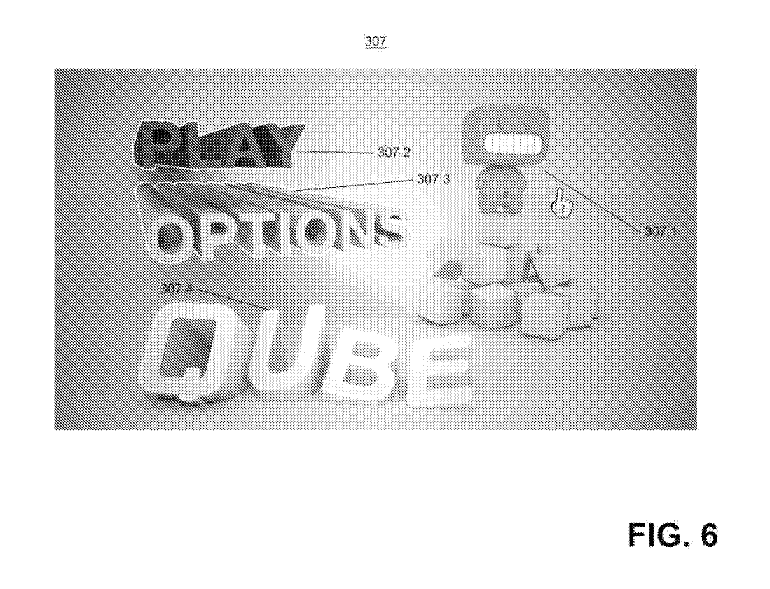

FIG. 6 illustrates an example Main Menu 307. Main Menu 307 may allow to perform selections (controllers 202 or 203 or 204 or 205 or 206 or combined can be used to perform such selections) on an animated 3D mascot 307.1, on the Play selection 307.2, Options selection 307.3 and on Qube selection 307.4. With selection 307.1 on animated 3D mascot player may play Tutorial 318. With selection 307.2 player may access to “Play” menu 310 where a different video games may be presented. With selection 307.3 player may access the “Options” menu 309. With selection 307.4 player may display in-game Credits 308.

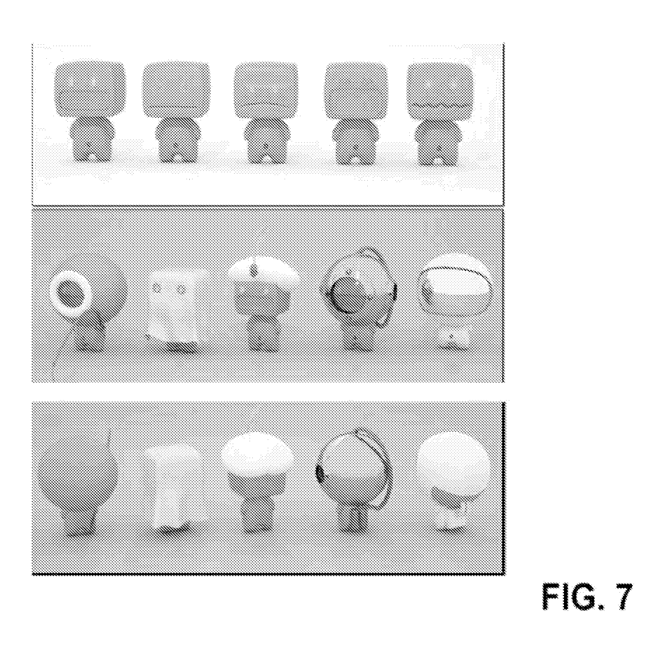

FIG. 7 illustrates example of 3D mascot 307.1 animations, arts and designs that can be included in a video game.

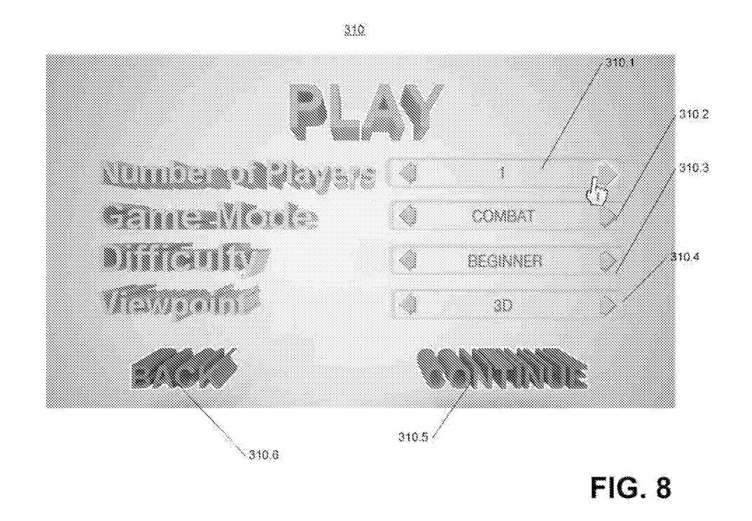

FIG. 8 illustrates the Play menu 310. Play menu presents a series of game options and video games to be played by player. In selection 310.1 (Number of Players) player needs to select the number of players in the game. The maximum number of players that could simultaneously play the game is 4 (humans and/or computer artificial intelligence). 2 players and above during the same game session (including 1 human versus computer artificial intelligence) can play without Split Screen mode (using the same 3D environment and different “Tetraminoes” grids). With selection 310.2 (Game Mode) player may select the game mode from the following game modes: Marathon, Time Attack, The Match. In selection 310.3 player may choose “Difficulty” level between: Beginner, Easy, Medium, Hard, Crazy levels. With selection 310.4 player may choose “Viewpoint” or visualization mode on TV screen or computer monitor: possible selections are 2D, 3D, 1st Person. With selection 310.5 player chooses to continue to the next menu 313, with selection 310.6 player chooses to go back to Main Menu 307.

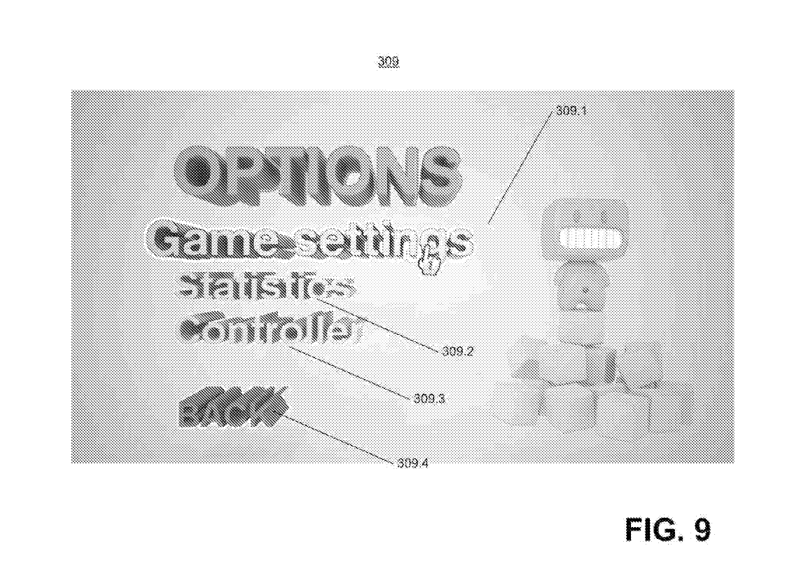

FIG. 9 illustrates the Options menu 309. Options menu present various settings that can be adjusted in the video game. In selection 309.1 (Game Settings) player may set different game settings such as Viewpoint, Music Volume and SFX Volume (special effects volume). In selection 309.2 (Statistics) player may review different videogame information such as top scores and other player statistics. In selection 309.3 (Controllers) player may change controllers 202, 203, 204, 205, 206 settings, including 208.1, 208.2 and 209 devices configuration, choose the default/preferred video game controller and change input/control settings. With selection 309.4 (“Back” button on graphic interface) player may decide to go back to Main Menu 307.

The Credits menu 308 allows player to review the in-game credits. A “Back” button in the graphic interface 308 will allow to go back to Main Menu 307.

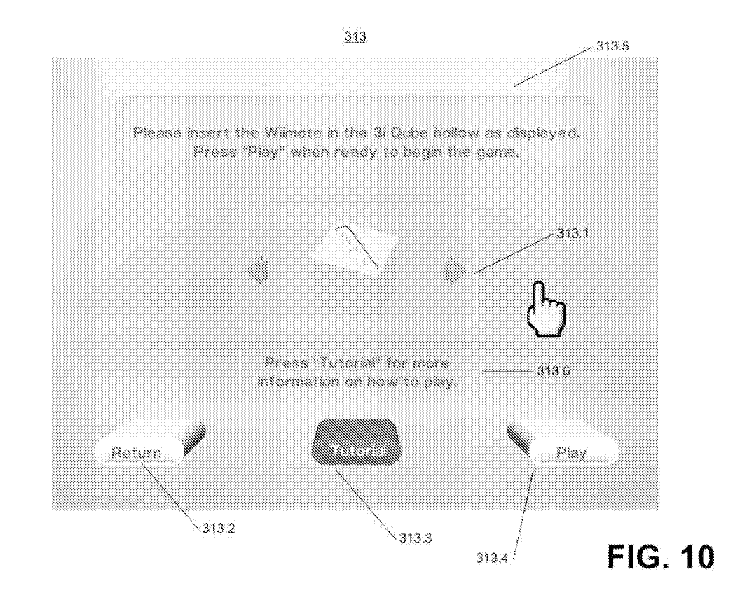

FIG. 10 illustrates an example Recap Screen 313. From this menu interface player may select preferred input/control method and configuration from 313.1. In example, player may choose to play with device 202 configured with device 208.1, or to play with device 202 and 203 configured with device 209 (depending on the selected Viewpoint 310.4, different controller configurations may be presented). An information box 313.5 is displayed to provide information about how to use the devices. Player may select 313.2 to go back to Play menu 310, or select 313.3 to play Tutorial 318 (information box 313.6 is displayed), or choose to continue to 314 by selecting 313.4.

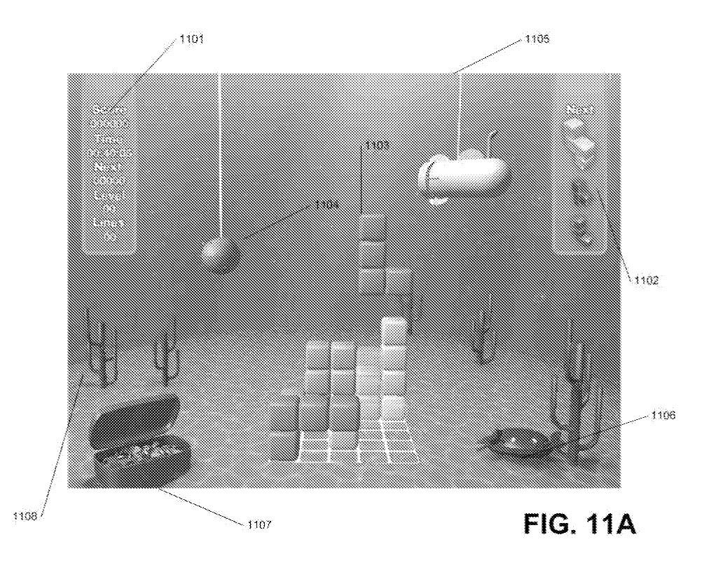

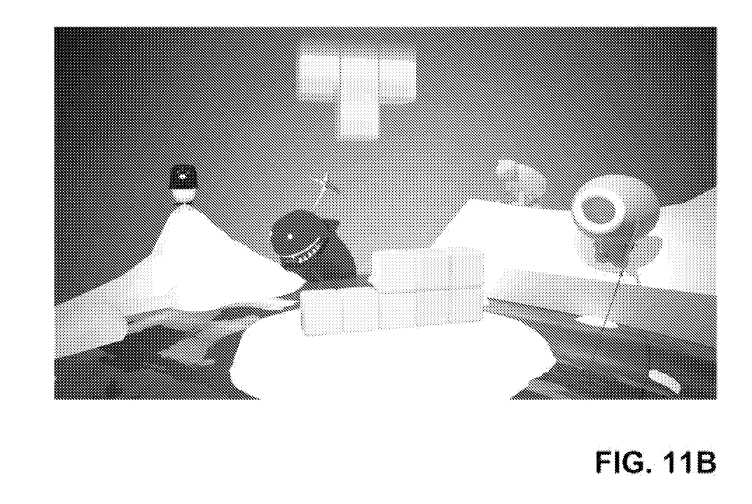

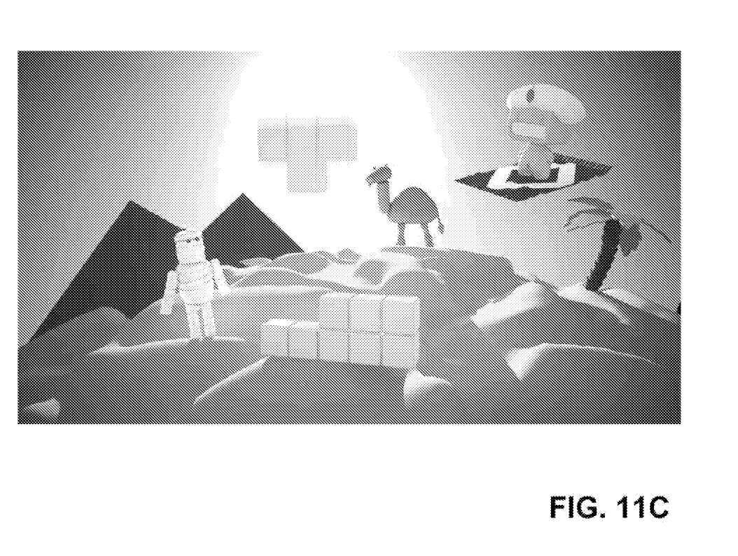

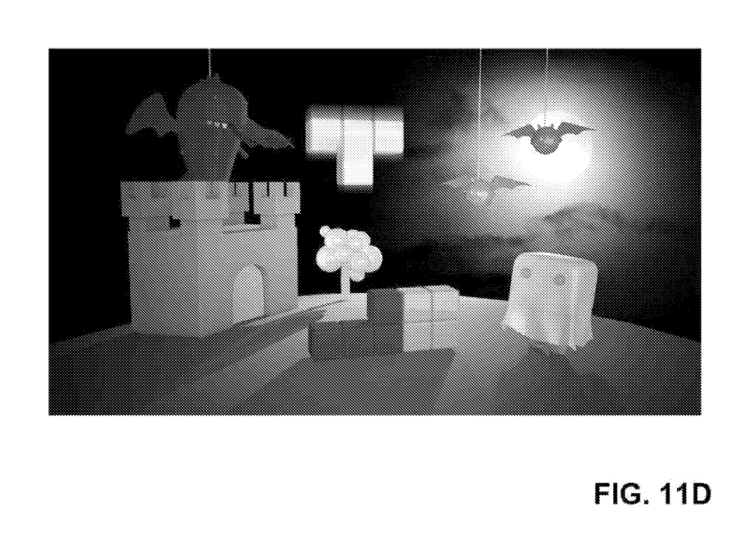

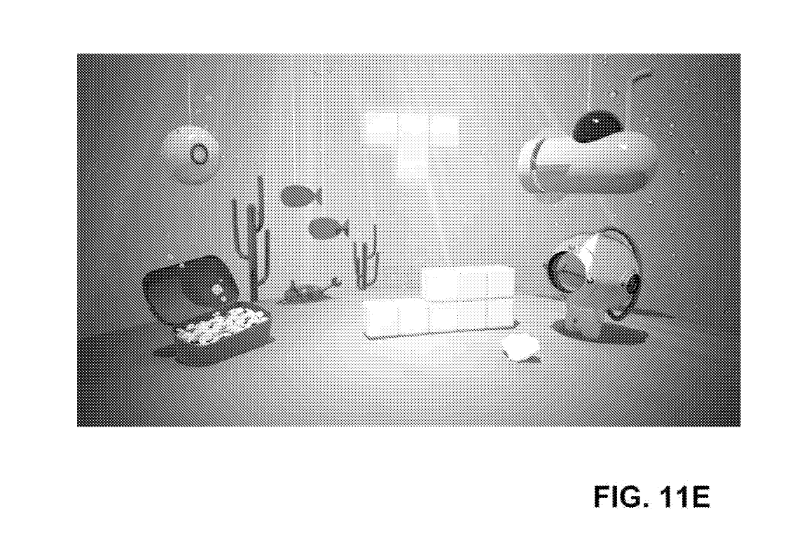

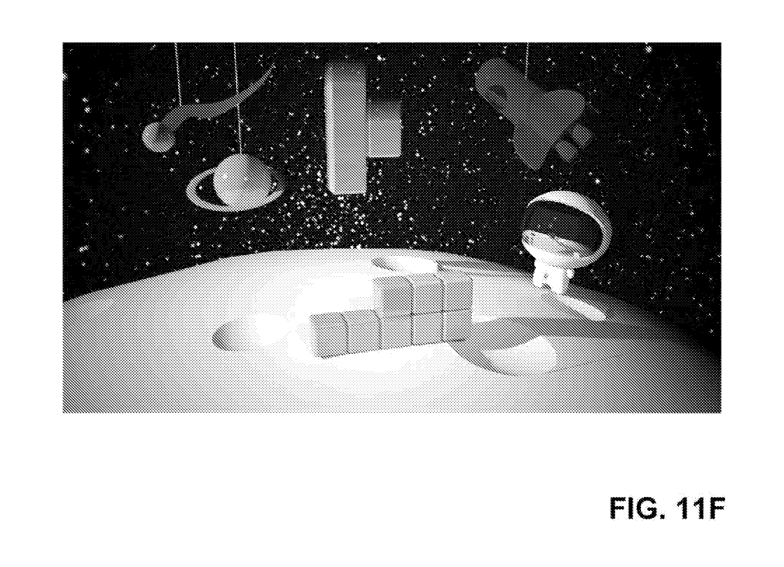

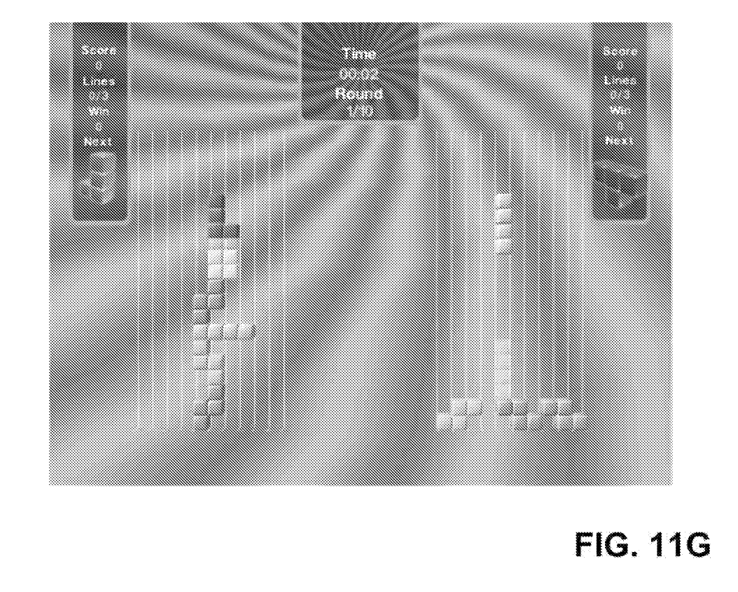

FIGS. 11A, 11B, 11C, 11D, 11E, 11F, 11G illustrate example Gameplay 314 interface, where player may play different video games with different game options and within different background animations and environments/themes. FIG. 11A illustrates an example video game session where player may perform physical actions using control/input devices in combination with devices 208.1 or 208.2 and/or 209: those actions will be reflected on screen through 3D objects animations and movements. In one example, using device 202 configured with device 208.1, player may move and rotate the falling “Tetraminoes” 1103 displayed on screen. To pass the stage to the next level player should reach a set score, avoiding the “Tetraminoes” pile reaches a set height, by “clearing” lines (“clearing” a line means to build a line of the same color on screen by using and moving the falling blocks. Such line is automatically cancelled—so, “cleared”—from the screen and the blocks above fall down). By clearing “Tetraminoes” lines player may collect different amount of game points. Different game modes, different blocks, different objects and different use of blocks may be included in the game play. In the above example, the “Tetraminoes” may be shaped in 3D format or 2D format depending on the “Viewpoint” selection made in Recap Screen 313 or in Game Settings screen 319. The head-up display (HUD), so the in-game graphical user interface, may include real time information box 1101 presenting different information such as, but not limited to, game Score, game play Time or time countdown, current Level, Lines completed. Information box 1102 may display the next “Tetraminoes” that will be falling from the top of the screen. Elements 1104, 1105, 1106, 1107, 1108 may be animated 3D objects used to create video game variability and dynamism and which may interfere or interact with player in-game actions enhancing the game play. In one example, a treasure box 1107 may open under specific conditions such as clearing a set number of blocks lines.

FIG. 11B illustrates the in-game 3D environment named “Ice”. This environment may include different 3D animated and interacting objects, such as a 3D mascot as illustrated in FIG. 7, or other elements which are interacting with the game play and responding to specific player's in-game actions. In one example, player by “shaking” control/input device 202 (configured or not with 208.1) generates the same effects in the game, so the screen will be shaking with rumble noise. In this example different 3D objects will respond to player's action: the animated and stylized 3D polar bear may slip falling on ice (idle state: walking on ice); the 3D penguin may slip falling in the water (idle state: ready to jump in the water) then surfacing from the water and reaching the idle state again. Consequent audio effects are included in combination with animations and graphic effects. In another example, the “Tetraminoes” by falling on grid may emit iced-smoke. In yet another example, different audio and graphic effects may be used if clearing “Tetraminoes” lines: 1 line—blocks ice over and break; 2 lines—killer whale jump; 3 lines—mascot starts fishing 3D blocks fell in water, then stop fishing going idle state again; 4 lines—penguins on an iced platform, killer whale jump out from water falling in front of penguins, penguins run away out of screen, killer whale jump back in water, penguins come in back to idle state. In another example, a game-over event may be triggered if player loses the match: an iced wall falls from above, the mascot animates and start knocking on the wall, then goes away in angry state.

FIG. 11C illustrates the in-game 3D environment named “Desert”. This environment may include different 3D animated and interacting objects, such as a 3D mascot as illustrated in FIG. 7, or other elements which are interacting with the game play and responding to specific player's in-game actions. In one example, player by “shaking” control/input device 202 (configured or not with 208.1) generates the same effects in the game, so the screen will be shaking with rumble noise. In this example different 3D objects will respond to player's action: a coconut falls from the palm (idle state: palm sways in the breeze); camel bump sways (idle state: calm camel eating); Pyramid breaks in two pieces, another shake and the Pyramid patches up. Consequent audio effects are included in combination with animations and graphic effects. In another example, the “Tetraminoes” by falling on grid may cause sand scattering from the ground. In yet another example, different audio and graphic effects may be used if clearing “Tetraminoes” lines: 1 line—blocks petrify and become sand; 2 lines—mascot over the flying carpet start flying around like crazy. Mascot gets scared and becomes a cube. Once flying carpet stops mascot opens again (idle state); 3 lines—a big mummy appears from behind the Pyramids overcoming them menacingly, the mummy, due to heat, gets tired and decides to lie down on sand. For subsequent 3 lines clearing lied down mummy drinks a cocktail; 4 lines—mascot on flying carpet flies down on sand and starts playing flute. A serpent appears and tries to byte mascot, mascot throws away flute and reaches idle state. In another example, a game-over event may be triggered if player loses the match.

FIG. 11D illustrates the in-game 3D environment named “Hunted Castle”. This environment may include different 3D animated and interacting objects, such as a 3D mascot as illustrated in FIG. 7, or other elements which are interacting with the game play and responding to specific player's in-game actions. In one example, player by “shaking” control/input device 202 (configured or not with 208.1) generates the same effects in the game, so the screen will be shaking with rumble noise. In this example different 3D objects will respond to player's action: castle breaks in the center, a magic spell patches it up, an evil laugh is heard; lightning with thunder audio effect. Consequent audio effects are included in combination with animations and graphic effects. In another example, castle door may open with scaring audio effects and evil laughs. In yet another example, trees sway. In another example, the “Tetraminoes” by falling on grid may cause dust, grass pieces and insects scattering from ground. In yet another example, different audio and graphic effects may be used if clearing “Tetraminoes” lines: 1 line—small phantoms fly away from the cleared line; 2 lines—bats come in and start fighting each other (idle state: bats get quit flying normally); 3 lines—mascot wearing “phantom” clothes start moving in the scene trying to scare everybody (audio effects with mascot evil laugh and screaming) then reverting back to idle state; 4 lines—a dragon appears from behind the castle, it watches the tree burning it with its fire. Burned tree disappears and dragon moves out the screen disappearing behind castle. After a while a new tree arises from the ground. In another example, a game-over event may be triggered if player loses the match: dragon appears and burns all the “Tetraminoes”. Scared mascot runs away. Game Over text appears.

FIG. 11E illustrates the in-game 3D environment named “Underwater”. This environment may include different 3D animated and interacting objects, such as a 3D mascot as illustrated in FIG. 7, or other elements which are interacting with the game play and responding to specific player's in-game actions. In one example, player by “shaking” control/input device 202 (configured or not with 208.1) generates the same effects in the game, so the screen will be shaking with rumble noise. In this example different 3D objects will respond to player's action: seaweeds sway with raised intensity, submarine slants appearing to break the cord, seashell opens and eyes look around then closes again. Consequent audio effects are included in combination with animations and graphic effects. In another example, the “Tetraminoes” by falling on grid may cause sand scattering from ground. In yet another example, different audio and graphic effects may be used if clearing “Tetraminoes” lines: 1 line—air bubbles released from the ground after awhile they explode; 2 lines—a hook attached to a cord enters water catching the animated fishes. Hook, cord, fishes exit the screen and new animated fishes appear in the water; 3 lines—mascot sees a seashell, picks it up then throws it against the treasure box. The treasure box opens and all diamonds, gold, bubbles etc escape; 4 lines—the ball fish swells releasing air bubbles and flying like crazy in different directions, hitting screen sides, cord drops off (idle state: ball fish inflates and deflates releasing bubbles from the mouth). In another example, a game-over event may be triggered if player loses the match: an oil barrel falls down in the water releasing oil and obscuring the entire screen. Mascot tries to swim out of water but without success and so Mascot surrenders looking at the player in a sad manner keeping arms crossed while falling below. Game Over text appears.

FIG. 11F illustrates the in-game 3D environment named “Moon”. This environment may include different 3D animated and interacting objects, such as a 3D mascot as illustrated in FIG. 7, or other elements which are interacting with the game play and responding to specific player's in-game actions. In one example, player by “shaking” control/input device 202 (configured or not with 208.1) generates the same effects in the game, so the screen will be shaking with rumble noise. In this example different 3D objects will respond to player's action: planet ring falls aside then return to idle state moving around the planet, an animated comet centre breaks then returning in idle state moving around on screen. Consequent audio effects are included in combination with animations and graphic effects. In another example, the “Tetraminoes” by falling on grid may cause lunar sand scattering from ground. In yet another example, different audio and graphic effects may be used if clearing “Tetraminoes” lines: 1 line—falling stars in the background; 2 lines—an animated space shuttle moving around switches its engines on and starts turning around itself attached to the cord then going back idle state (moving around attached to the cord); 3 lines—a meteor falls on the planet creating a crater that slowly disappears; 4 lines—mascot tries to switch jet-pack on but it is not working. The mascot surrenders but suddenly the jet-pack self-starts and mascot flies away hitting its head on screen “virtual glass”. Then mascot falls back on the planet surface reaching idle state again. In another example, a game-over event may be triggered if player loses the match: mascot reaches the “Tetraminoes” grid pissing on some blocks. The mascot starts jet-pack flying away. Game Over text appears.

FIG. 11G illustrates another example in-game graphic interface for multiplayer mode in 2D Viewpoint.

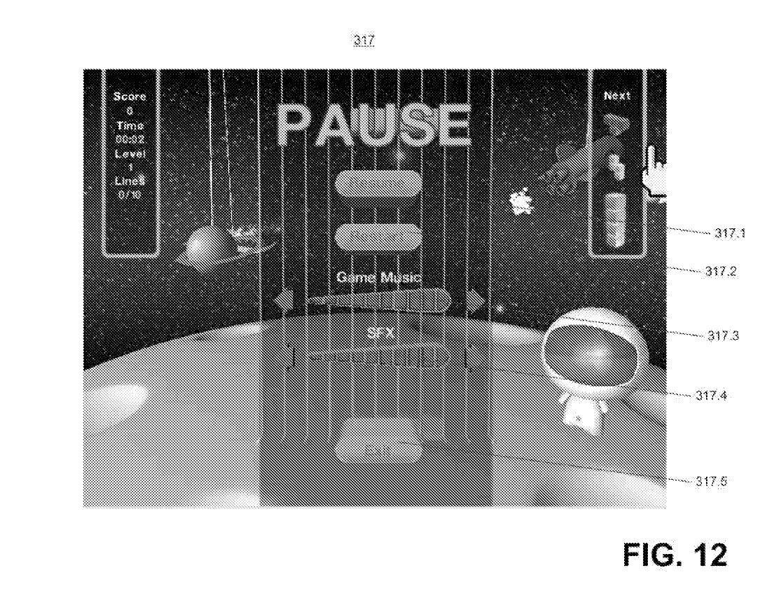

FIG. 12 illustrates an example Pause menu interface 317. By pressing a set button on control/input device 202 or 203 or performing other actions player may put on hold the game play session pausing the game. From this menu player may choose to resume current game 317.1, restart the current game from the beginning (so losing the earned points and score) 317.2, adjust in Game Music 317.3, adjust audio effects (SFX) 317.4 or Exit the current game session 317.5 going back to Main Menu 307.

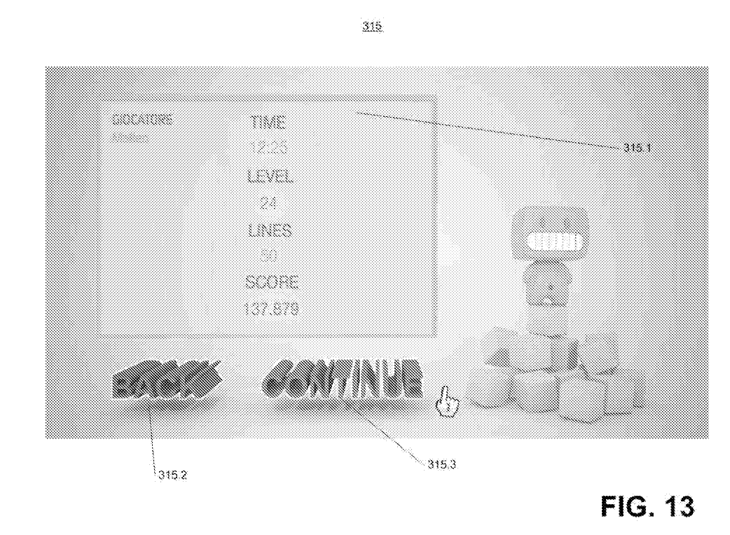

FIG. 13 illustrates an example End Screen menu interface 315. In this menu player may: review the results of the game session (box 315.1), continue to the Main Menu 307 (button 315.3), go back restarting the game (button 315.2).

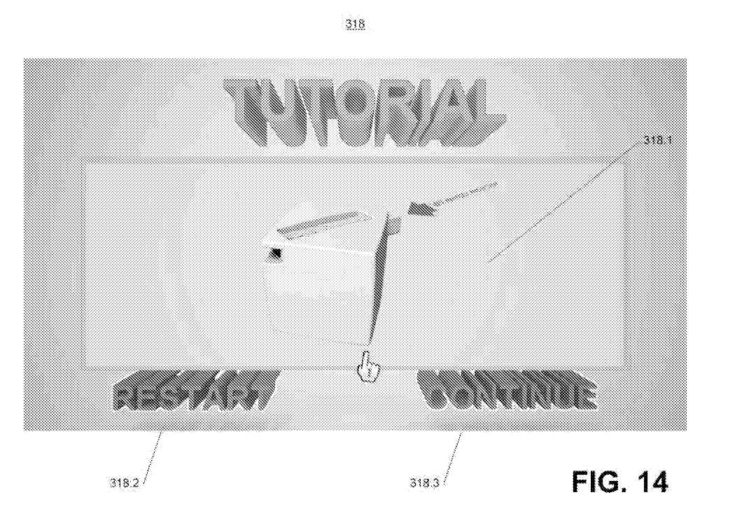

FIG. 14 illustrates an example Tutorial menu interface 318. Depending on the selected controller configuration as set in Controllers menu 321 (for example, device 202 combined with device 208.1), this menu may present, through videos, cinematics, slides and texts, information about how to use the configured controllers and/or devices to play the game. Tutorial menu interface may be accessible from Main Menu 307 or from Controllers menu 321 or from Recap Screen 313. When starting Tutorial menu 318 player information boxes 318.1 may be presented, summarizing basic information on how to use control/input devices selected configuration. Once started, tutorial may be entirely played through animated slides and movies or interactive screens. From interface menu 318 player may choose: to continue to the previous menu (307 or 321 or 313) by selecting button 318.3; to re-play tutorial from the beginning by selecting button 381.2 on interface.

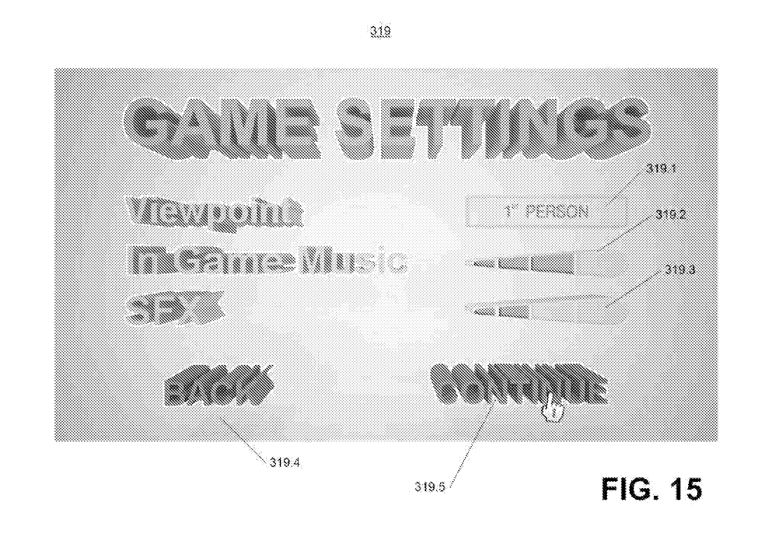

FIG. 15 illustrates an example Game Settings menu interface 319. From this menu player may change different game settings. In one example, player may change Viewpoint 319.1, Music Volume 319.2, audio special effects (SFX) volume 319.3. By selecting “Continue” button 319.5 player may save selected settings then go back to Options menu 309. By selecting “Back” button 319.4 player may go back to Options menu 309 without saving changes.

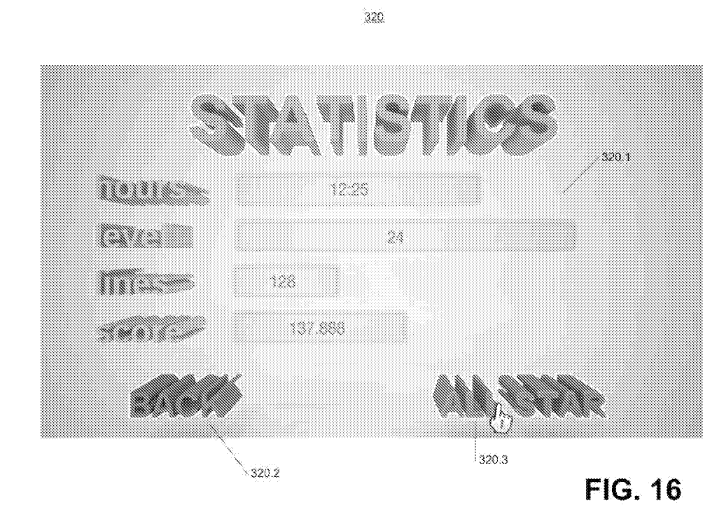

FIG. 16 illustrates an example Statistics menu interface 320. From this menu interface player may get information about its performance in the video game, the achieved results and top scores and comparison of results/scores among different saved profiles. In one example, from the information box 320.1 player may review: total hours of game play, maximum in-game level reached, total lines cleared, total score. With selection of “Back” button 320.2 player may go back to Options menu 309. With selection of “All Star” button 320.3 player may review a comparison table with achieved results compared with results and information from other saved profiles: compared information could include, but not limited to, top score, game mode, levels completed, lines cleared.

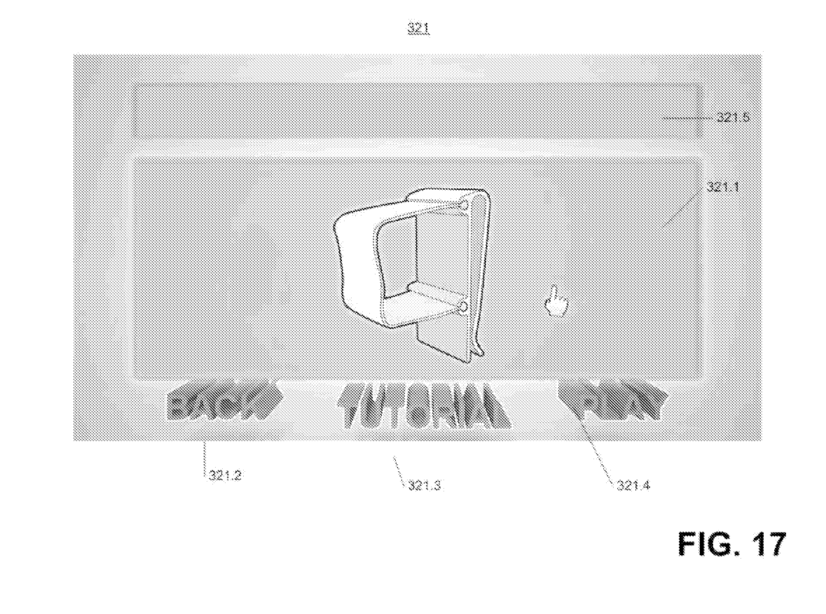

FIG. 17 illustrates an example Controllers menu interface 321. From this menu interface player may set the controller to be used in the video game by combination of one or more control/input devices 202, 203, 204, 205, 206 with one or more devices 208.1, 208.2 or 209. In one example, with selection box 321.1 player may choose from a list of different combination, from a combination of 202 device and 208.1 device to a combination of 202 and 203 devices and 209 device. Other combinations may be possible depending on the video game and future applications. In another example, an information box 321.5 may present textual information about the selected controller configuration. With selection 321.2, choosing “Back” button, play may go back to Options menu 309 without saving the preferred controller configuration. With selection 321.3 (“Tutorial” button) player can start the Tutorial 318. With selection 321.4 (“Play” button that may be, alternatively, substituted with a “Continue” button) player may choose to save the selected and preferred controller configuration going back to Options menu 309. The preferred and saved controller configuration will be used as default configuration in all included video games. Player may decide at any time to change this selection by accessing Controllers menu 321.

Accessing Play menu interface 310 player may change different settings before the video game starts. Player may choose to change: Number of Players 310.1, Game Mode 310.2, Difficulty 310.3, Viewpoint 310.4.

In one example, Number of Players 310.1 may represent the number of players that simultaneously play the selected video game. The maximum Number of Players would be 4 (humans and/or computer artificial intelligence), 2 players minimum and above for multiplayer mode (video game would be presented in one screen with 2 or more “Tetraminoes” grids and piles, no split screen is used).

In another example, Game Mode 310.2 may include different modes to play video game such as: Marathon (Single player and Multi Player), Time Attack (Single player and Multi Player), The Match (Single player and Multi Player). In Marathon game mode, single or multi player game, the game may start from level 1 with an empty screen, each 10 lines one level is completed. For each completed level the speed of blocks is increased by a percentage. The same graphic theme/environment (selected from Ice, Desert, Hunted Castle, Underwater, Moon) is used in 2 sequential levels, after 2 levels the theme changes. After level 10 the environments/themes repeat randomly. In Time Attack game mode, single or multi player mode, the game may include a standard “clear lines” mode but with a variation: player may need to clear a certain amount of lines within a time limit. If player succeed, a time bonus may be added to the time left and the number of lines to complete will be increased by a factor. If player fails, the system may increase difficulty level, time bonuses may be added and number of lines increased, but a set number of blocks may be added on grid as a penalties. The levels swap after 10 lines cleared. Each 2 levels correspond to a single environment/them (from Ice, Hunted Castle, Desert, Underwater, Moon). After 100 lines cleared (10 levels) the environment/theme may randomly change every 2 levels. The Match game mode, single or multi player mode, may consist of a battle between players, may be used Split Screen graphic interface or not. Each player may disturb the opponents using bonuses collected when lines with special blocks are completed (bonuses may consists of graphic objects such as: bombs, obstacles, freeze, rotate a block, etc. Bonuses influences the game play by introducing variability and new dynamics). Player may play against other players in 10 rounds. Each round is won by the player clearing 10 lines before the others. Once a round is completed the system switches to another round. At the end, the player who wins more rounds wins the match. The opponent could be human or computer artificial intelligence. Once the match is over player may decide to restart a new match or to go back to the Play menu 310.

In yet another example, player may set Difficulty level 310.3 from a list of difficulty levels. Each Difficulty level change the game play thanks to the combination of a penalty/reward system and game play speed. In example, player may choose the following levels: Beginner (20% penalty on scored points, 20% lower speed), Easy (10% penalty on scored points, 10% lower speed), Medium (no penalties and default speed), Hard (10% reward on scored points, 10% higher speed), Crazy (20% reward on scored points, 20% higher speed).

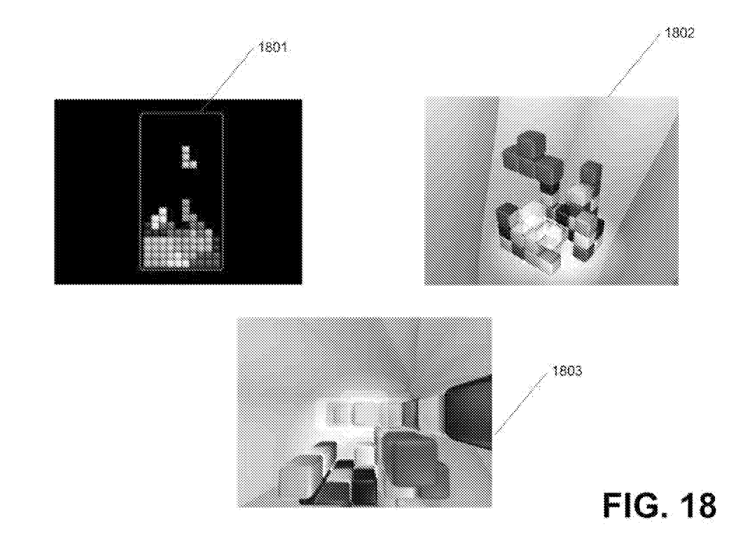

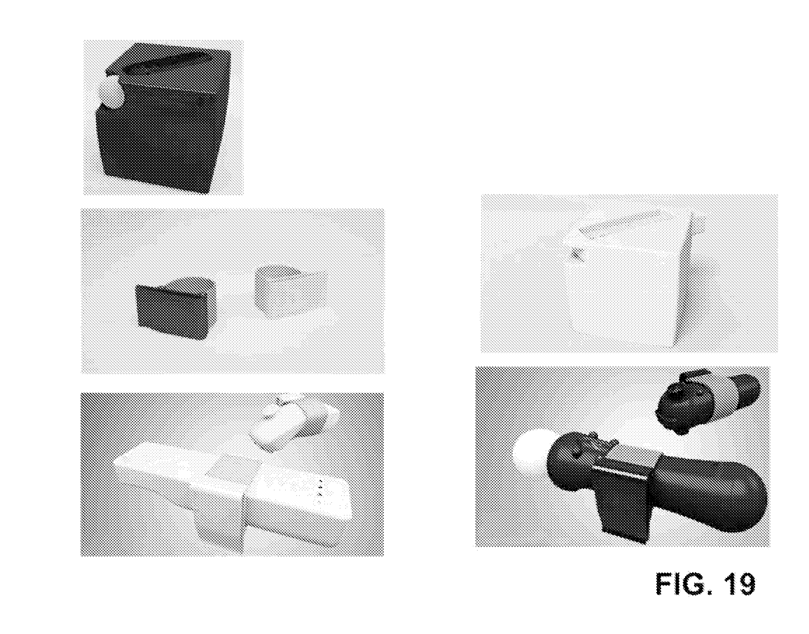

In another example, player may set the Viewpoint 310.4. FIG. 18 illustrates an example selectable Viewpoint mode, from: (i) 2D mode, example 1801 in FIG. 18, which is the classic two-dimensional view; (ii) 3D mode, third person view, example 1802 in FIG. 18, where blocks may be displayed as 3D objects within a 3D space/environment. The 3D objects move along tridimensional axis. Player, by manipulating control/input devices combined with 208.1, 208.2 or 209 devices may replicate movements in the 3D space represented on the screen by moving the falling 3D block; (iii) 3D mode, first person view, example 1803 in FIG. 18, where blocks are 3D objects in a 3D space but player is identified and represented in the game as the falling block. In this case player “is” the falling block and, in one example, player, by playing with control/input devices 202 and 203 combined with device 209, may move the 3D object on screen by moving its physical body. Viewpoint selection 310.4 influences the default controller configuration presented by the system (the right controller configuration is selected for the selected Viewpoint).

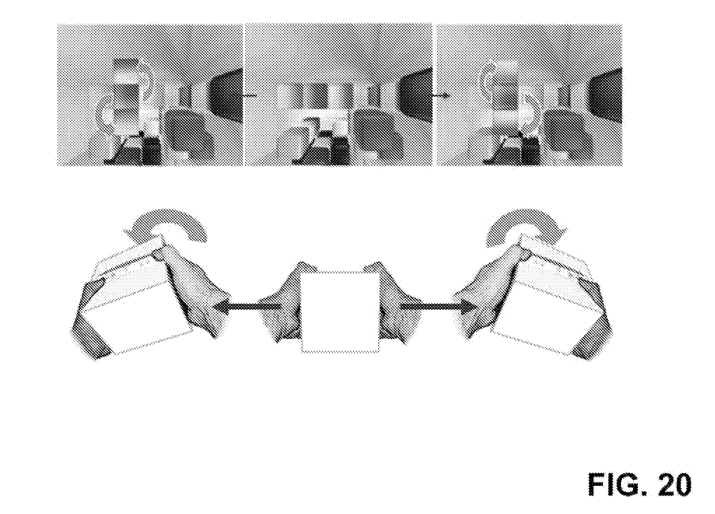

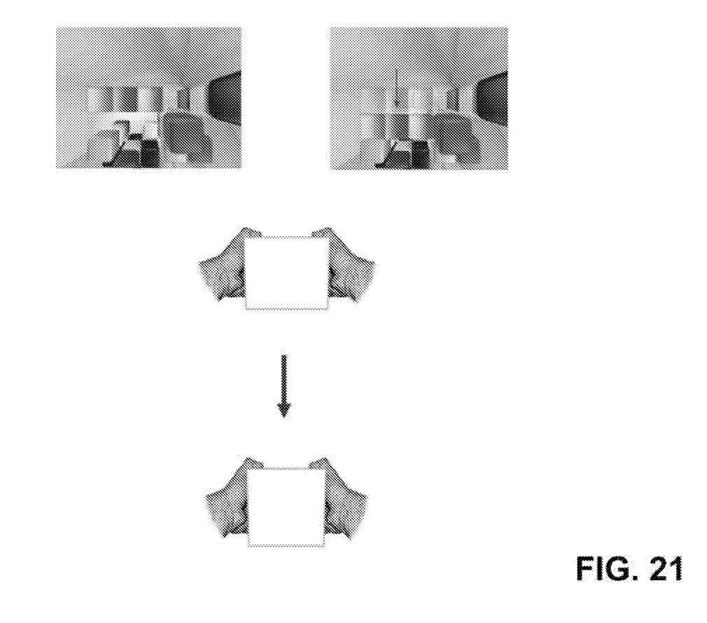

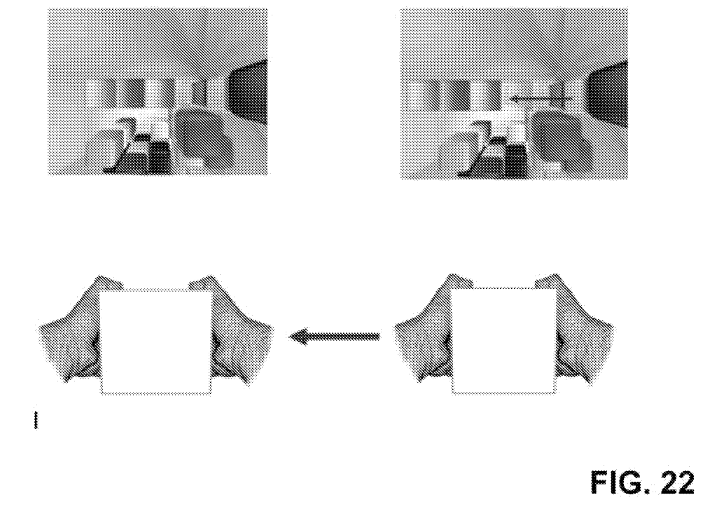

FIG. 20, FIG. 21 and FIG. 22 illustrate example of game play commanding game actions through combination of control/input device 202 and device 209.

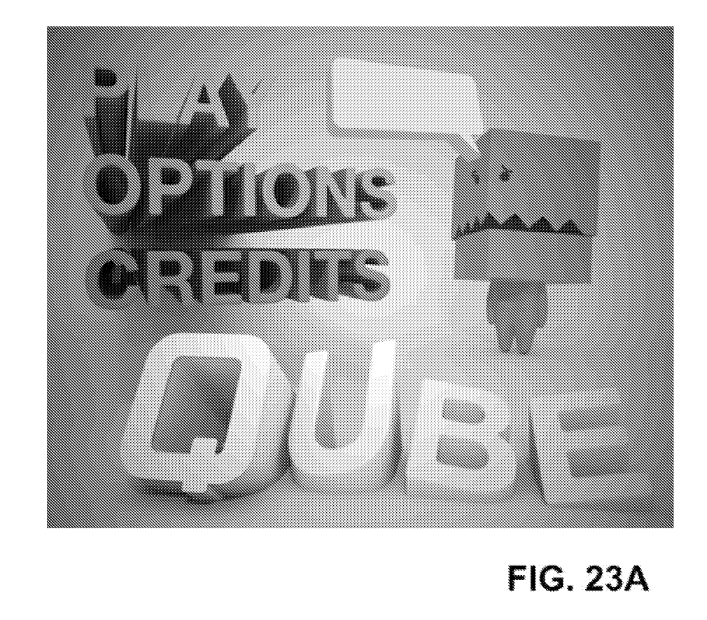

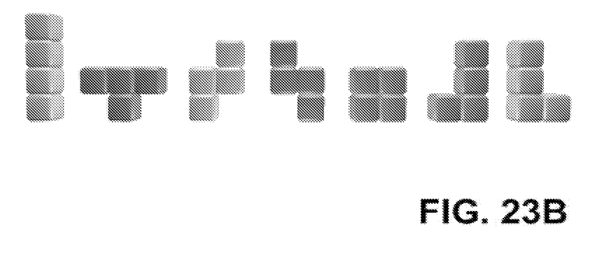

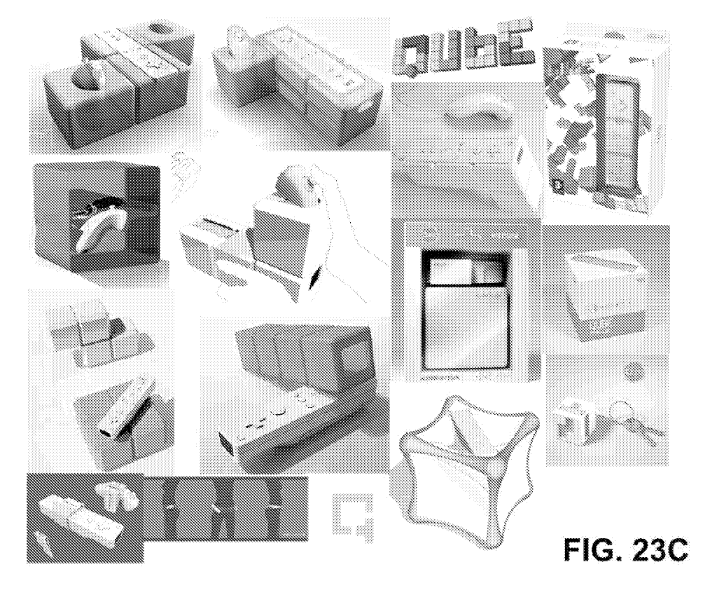

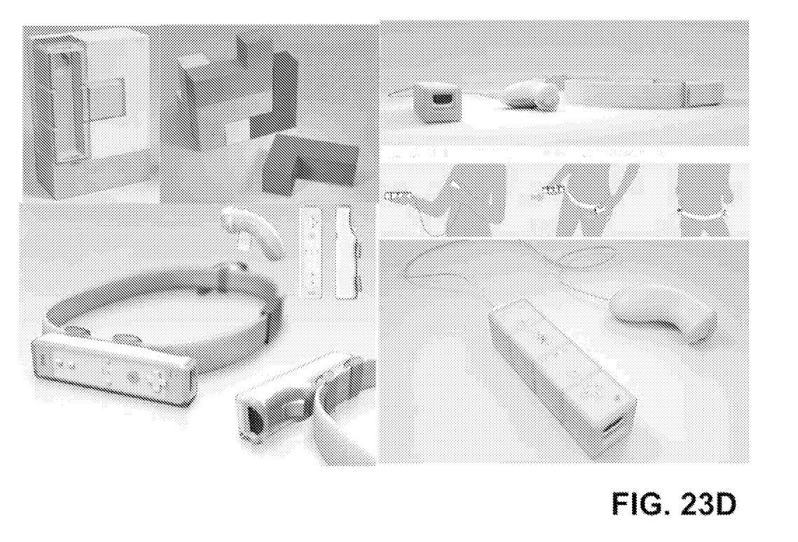

FIGS. 23A, 23B, 23C, 23D illustrate example concept design about one or more aspects described herein.

One or more aspects described herein may be embodied in computer-usable data and computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

In addition, the description includes one or more inventions that may be used alone or in combination with each other. For example, the devices 208.1, 208.2 and 209 may be used with the described games and software, or with other games and software. The devices may be used with any game console, computing device, server, digital video recorder (DVR), mobile device, networked device, etc. The described games and game modes, Viewpoint (visualization mode) or graphic style, may be used in combination with devices 208.1, 208.2 or 209 or not, and may be played in different manners than specifically described. In another example, the game play inventions and game concepts presented herein may be used in combination with different devices than 208.1, 208.2 and 209 such as, but not limited to, devices 202, 203, 204, 205, 206. The provided descriptions are for illustrative purposes to enable multiple embodiments of each invention contained herein. Applicant reserves the right to pursue each invention individually or in combination with one or more other inventions described herein.

Although the subject matter has been described in language specific to structural features and/or methodological acts, it is to be understood that the subject matter described herein is not limited to the specific features, embodiment, aspects, or acts described. Rather, the specific descriptions herein are provided as example and illustrative forms of implementing one or more aspects of the invention.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A method of physical manipulation of a made of different material (plastic, sponge, etc) and/or different colors and/or shapes cube or polygon, configured for use with different input devices, in order to command movements of 2D or 3D virtual blocks, “Tetraminoes”, game characters or movement of any other object or polygon made object represented and displayed on a TV screen or computer monitor.

2. The method of claim 1, wherein the video game includes movements and/or actions on 2D or 3D blocks, polygons or other similar objects (like in puzzle games, platform games, etc.) as relevant elements of the game play.

3. The method of claim 1, wherein the video game requires first person view or player identification with one character or element of the game;

4. The method of claim 1, wherein the video game requires use of a video camera as input device;

5. The method of claim 1, wherein the active player input corresponds to a detected motion of a controller device;

6. The method of claim 1, wherein the active player input corresponds to the pressing of a button;

7. A method, comprising:
using of plastic or made of different material and/or different colors and/or shapes clips or belt worn on player's hips as holders of control/input devices in order play games through body movements;
using of plastic or made of different material and/or different colors and/or shapes clips belt as holders of such devices, for quick and easy access to controllers commands and buttons.

8. The method of claim 7, wherein the video game requires player to put one or more of the standard control/input devices away from hand/s in order to use another additional device to play game (like microphone to play singing games, etc.). Standard control/input devices means the control/input devices which are commonly recognized as default devices on the target game system (such as Wii-Mote and Nunchuk on Nintendo Wii console, etc.).

9. The method of claim 7, wherein the video game requires body movements using motion detection input devices and such movements are performed without keeping controllers in player's hands.

10. A method, comprising:
receiving, from a control/input device, active player input corresponding to movement of at least a portion of the player;
controlling elements of the video game based on player body movements.

11. The method of claim 10, wherein the video game includes concepts, graphic design, arts, characters, animations, levels, story, game modes or game mechanics according and/or similar to one or more aspects described herein.

12. The method of claim 10, wherein the video game requires first person view or player identification with one character or element of the game and includes concepts, graphic design, arts, characters, animations, levels, story, game modes or game mechanics according and/or similar to one or more aspects described herein;

13. The method of claim 10, wherein the video game requires use of a video camera as input device and includes concepts, graphic design, arts, characters, animations, levels, story, game modes or game mechanics according and/or similar to one or more aspects described herein;

14. The method of claim 10, wherein the active player input corresponds to a detected motion of a controller device and includes concepts, graphic design, arts, characters, animations, levels, story, game modes or game mechanics according and/or similar to one or more aspects described herein;

15. The method of claim 10, wherein the player input by body movement may be combined or alternated with player input corresponding to the pressing of a button and includes concepts, graphic design, arts, characters, animations, levels, story, game modes or game mechanics according and/or similar to one or more aspects described herein.
